(19) United States
(12) Patent Application Publication
(10) Pub. No.: US 2024/0326163 A1
(43) Pub. Date: Oct. 3, 2024

(54) LASER PROCESSING APPARATUS

(71) Applicant: TOYOTA JIDOSHA KABUSHIKI KAISHA, Toyota-shi (JP)

(72) Inventors: Ryuta MATSUO, Nagakute-shi (JP); Takeshi YAMAMOTO, Nisshin-shi (JP)

(73) Assignee: TOYOTA JIDOSHA KABUSHIKI KAISHA, Toyota-shi (JP)

(21) Appl. No.: 18/602,495

(22) Filed: Mar. 12, 2024

(30) Foreign Application Priority Data
Mar. 28, 2023 (JP) 2023-050741

(51) Int. Cl. B23K 26/06; B23K 26/03; B23K 26/066

(52) U.S. Cl. CPC B23K 26/0648; B23K 26/032; B23K 26/066

(57) ABSTRACT

A laser processing apparatus having high accuracy of measurement of reflected light is provided. A laser processing apparatus according to the present disclosure includes: a laser oscillator configured to emit a laser beam to a workpiece; a sensor configured to measure intensity of light reflected from the workpiece; and a plate-like member disposed in the middle of an optical path of the reflected light, in which a through-hole is formed at a place in the plate-like member through which the reflected light passes, and the sensor measures the intensity of the reflected light that has passed through the through-hole. Therefore, it is possible to prevent light reflected from any object or the like other than the surface of the workpiece from entering the sensor, and thereby to accurately measure the intensity of light reflected from the surface of the workpiece.

### CROSS REFERENCE TO RELATED APPLICATIONS

This application is based upon and claims the benefit of priority from Japanese patent application No. 2023-050741, filed on Mar. 28, 2023, the disclosure of which is incorporated herein in its entirety by reference.

### BACKGROUND

The present disclosure relates to a laser processing apparatus.

Regarding a laser processing apparatus that processes a workpiece by applying a laser beam thereto, a technique for determining whether the quality of the processing is good or poor by measuring light reflected from the workpiece is known.

For example, Japanese Unexamined Patent Application Publication No. 2023-020190 discloses a technique for determining whether the quality of laser processing is good or poor by measuring a measurement laser beam reflected on the surface of a workpiece.

### SUMMARY

The inventors have found the following problem in regard to such a laser processing apparatus.

In some cases, a laser beam is reflected on a structure or the like present in a laser processing apparatus, and the reflected laser beam enters a sensor. There is a possibility that when light reflected on any object or the like other than the surface of the workpiece enters a sensor, the accuracy of the measurement of reflected light reflected on the surface of the workpiece deteriorates.

The present disclosure has been made in view of the above-described problem, and an object thereof is to provide a laser processing apparatus having high accuracy of measurement of reflected light.

An aspect for achieving the above-described object is a laser processing apparatus including:
a laser oscillator configured to emit a laser beam to a workpiece;
a sensor configured to measure intensity of light reflected from the workpiece; and
a plate-like member disposed in the middle of an optical path of the reflected light, in which
a through-hole is formed at a place in the plate-like member through which the reflected light passes, and
the sensor measures the intensity of the reflected light that has passed through the through-hole.

According to the present disclosure, it is possible to provide a laser processing apparatus having high accuracy of measurement of reflected light.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram of a laser processing apparatus according to a first embodiment;

FIG. 2 is a schematic diagram of a laser processing apparatus according to a second embodiment;

FIG. 3 is a graph showing an example of measurement results when a plate-like member is provided; and

FIG. 4 is a graph showing an example of measurement results when no plate-like member is provided.

### DESCRIPTION OF EMBODIMENTS

Embodiments according to the present disclosure will be described hereinafter in detail with reference to the drawings. The same or corresponding elements are assigned the same reference numerals (or symbols) throughout the drawings, and redundant descriptions thereof will be omitted as appropriate for clarifying the description.

### First Embodiment

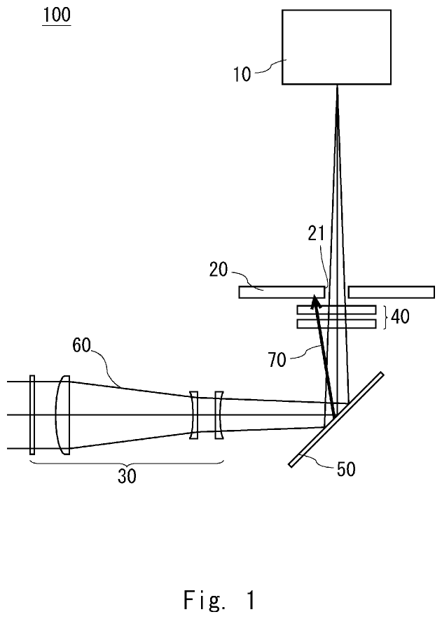

A configuration of a laser processing apparatus according to a first embodiment will be described with reference to FIG. 1. FIG. 1 is a schematic diagram of a laser processing apparatus according to the first embodiment. The laser processing apparatus 100 includes at least a laser oscillator (not shown), a sensor 10, and a plate-like member 20. The laser processing apparatus 100 may further include various members such as lenses 30, filters 40, and a reflector 50 as shown in FIG. 1. The laser processing apparatus 100 is an apparatus that laser-processes a workpiece (not shown) by applying a laser beam thereto, and determines whether the quality of the processing is good or poor.

The laser oscillator emits a laser beam having a predetermined wavelength. The laser processing apparatus 100 applies the laser beam emitted by the laser oscillator to the workpiece. As the laser beam is applied to the workpiece, it is laser-processed. A part of the laser beam applied to the workpiece is reflected on the surface of the workpiece. The sensor 10 is a sensor that measures the light reflected from the workpiece. The laser processing apparatus 100 determines whether the quality of the laser processing is good or poor based on the sensing result of the sensor 10.

An optical path 60 is an optical path of the reflected light from the workpiece to the sensor 10. As shown in FIG. 1, as a typical example, various members such as lenses 30, filters 40, and a reflector 50 are arranged on the optical path 60. For example, in the example shown in FIG. 1, the light reflected from the workpiece passes through the lenses 30, the reflector 50, and the filters 40 in this order, and then enters the sensor 10.

The lenses 30 are lenses for condensing (or focusing) the reflected light. The lenses 30 are arranged so as to condense (or focus) the reflected light near the sensor 10. A plurality of lenses 30 may be arranged as shown in FIG. 1. The filters 40 are a member(s) for extracting light having a predetermined characteristic(s), which passed through the filters 40, from the reflected light. The filters 40 are, for example, a band-pass filter (Band-pass filter, BPF) and an ND filter (Neutral Density Filter, NDF). The reflector 50 is a member for changing the direction in which the reflected light travels. In the example shown in FIG. 1, the reflector 50 bends the optical path 60 roughly at a right angle.

The plate-like member 20 is disposed in the middle of the optical path 60. When various members such as the lenses 30, the filters 40, and the reflector 50 are arranged on the optical path 60, the plate-like member 20 may be disposed between two of these members. For example, in the example shown in FIG. 1, the plate-like member 20 is disposed on the sensor 10 side of the filters 40. Note that the position of the plate-like member 20 is not limited to the above-described example. That is, the plate-like member 20 may be disposed at any position in the middle of the optical path 60.

The plate-like member 20 is a plate-like member formed by using a material that does not allow the reflected light to pass therethrough, and a through-hole 21 that penetrates from one surface of the plate-like member 20 to the other surface thereof is formed in the plate-like member 20. The plate-like member 20 is disposed at such a position that the reflected light passes through the through-hole 21. In other words, the through-hole 21 is provided at such a position in the plate-like member 20 that the reflected light passes through the through-hole 21. The sensor 10 measures intensity of the reflected light that has passed through the through-hole 21. In the example shown in FIG. 1, the plate-like member 20 is disposed so that the surfaces of the plate-like member 20 are perpendicular to the optical path 60, i.e., the perpendicular to the direction in which the reflected light travels.

The shape of the through-hole 21 when the plate-like member 20 is viewed from one side of the plate-like member 20 toward the other side thereof, i.e., the shape of the through-hole 21 when the plate-like member 20 is viewed from the filter 40 side in the example shown in FIG. 1, is not limited to any particular shapes as long as the reflected light can pass through the through-hole 21. The shape of the through-hole 21 when the plate-like member 20 is viewed from the filter 40 side in the example shown in FIG. 1 may be, for example, a circular shape or a rectangular shape.

The through-hole 21 is preferably provided in a position and preferably has an area (i.e., a size) in such a range that the light reflected from the surface of the workpiece can pass through the plate-like member 20 in order to increase the absorption ratio of light reflected from any object or the like other than the surface of the workpiece, and to enable the light reflected from the surface of the workpiece to sufficiently pass through the through-hole 21. That is, the through-hole 21 is preferably provided in such a position that the light reflected from the surface of the workpiece can pass through the through-hole 21, and has an area (i.e., a size) roughly equal to a range in which the reflected light can pass through near the plate-like member 20.

In some cases, the laser beam is reflected by a structure or the like present in the laser processing apparatus 100. Hereinafter, the light reflected by any object or the like other than the surface of the workpiece, i.e., the light reflected by a structure or the like present in the laser processing apparatus 100, is also referred to as “diffusely-reflected light”. The diffusely-reflected light travels along an optical path different from that of the light reflected on the surface of the workpiece. An optical path 70 shown in FIG. 1 is an example of the optical path of the diffusely-reflected light. As shown in FIG. 1, the diffusely-reflected light travels along the optical path 70, which is different from the optical path 60, so that it is absorbed by the plate-like member 20, i.e., cannot pass through the through-hole 21. As described above, in the laser processing apparatus 100, the diffusely-reflected light is absorbed by the plate-like member 20, so that the diffusely-reflected light is prevented from entering the sensor 10. Therefore, the laser processing apparatus 100 can measure the intensity of the light reflected from the workpiece more accurately than an apparatus including no plate-like member 20 can.

### Second Embodiment

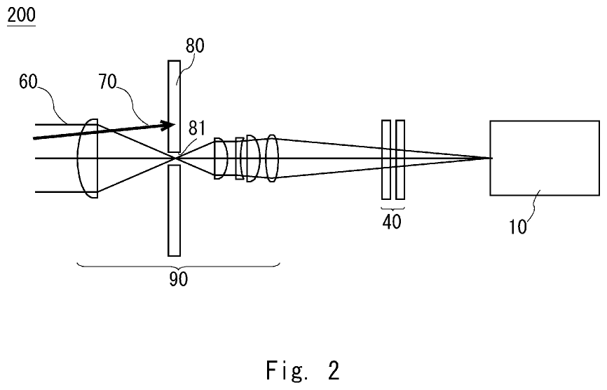

Next, a configuration of a laser processing apparatus according to a second embodiment will be described with reference to FIG. 2. FIG. 2 is a schematic diagram of a laser processing apparatus 200 according to the second embodiment. As shown in FIG. 2, the laser processing apparatus 200 includes a plate-like member 80 in place of the plate-like member 20 shown in FIG. 1, and lenses 90 in place of the lenses 30. The rest of the configuration is similar to that of the first embodiment, and therefore descriptions thereof will be omitted as appropriate.

The tenses 90 are lenses designed to condense (e.g., focus) the reflected light near the plate-like member 80. In the example shown in FIG. 2, the plate-like member 80 is disposed between two of the lenses 90. The plate-like member 80 has a through-hole 81. Since the light reflected from the workpiece is condensed (or focused) in the plate-like member 80, the plate-like member 80 may have a smaller through-hole than that of the plate-like member 20. Therefore, the plate-like member 80 can absorb the diffusely-reflected light more than the plate-like member 20 can. Accordingly, the laser processing apparatus 200 can measure the intensity of the light reflected from the workpiece more accurately.

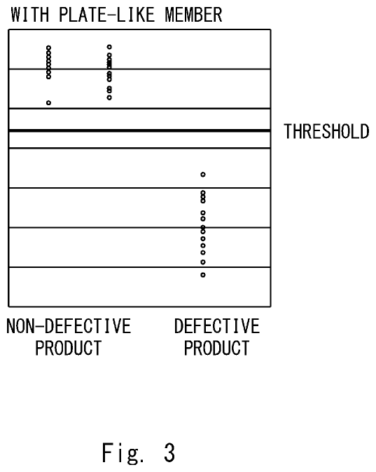

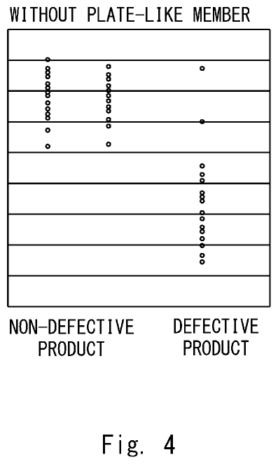

Next, results of measurement of reflected light using the laser processing apparatus 200 according to the second embodiment will be described with reference to FIGS. 3 and 4. FIG. 3 is a graph showing an example of measurement results when a plate-like member is provided. FIG. 4 is a graph showing an example of measurement results when no plate-like member is provided. Note that in each of FIGS. 3 and 4, the vertical axis of the graph indicates measurement scores of reflected light. Non-defective products shown in each of FIGS. 3 and 4 show results of measurement of intensity of reflected light for workpieces for which laser processing was excellently performed. Meanwhile, non-defective products shown in each of FIGS. 3 and 4 show results of measurement of intensity of reflected light for workpieces for which laser processing was poorly performed.

The graph shown in FIG. 3 shows results of measurement of intensity of reflected light in the laser processing apparatus 200 according to the second embodiment. As shown in FIG. 3, the measured scores of all the non-defective products were equal to or higher than a predetermined value. In contrast, the measured scores of all the defective products were lower than the predetermined value. Therefore, when intensity of reflected light is measured in the laser processing apparatus 200, a predetermined value can be set as a threshold. Then, when the measurement score of reflected light is equal to or higher than the threshold, the laser processing apparatus 200 can determine that the laser processing was excellently performed for the workpiece.

The graph shown in FIG. 4 shows results of measurement of intensity of reflected light in a laser processing apparatus in which no plate-like member 80 is provided. As shown in FIG. 4, the measured scores of some defective products were roughly equal to those of non-defective products. Therefore, in this case, it is not possible to set a predetermined value as a threshold.

By the embodiments described above, it is possible to provide a laser processing apparatus having high accuracy of measurement of reflected light.

Note that the present disclosure is not limited to the above-described embodiments, and they can be modified as appropriate without departing the scope and spirit of the disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A laser processing apparatus comprising:
a laser oscillator configured to emit a laser beam to a workpiece;
a sensor configured to measure intensity of light reflected from the workpiece; and
a plate-like member disposed in the middle of an optical path of the reflected light, wherein
a through-hole is formed at a place in the plate-like member through which the reflected light passes, and
the sensor measures the intensity of the reflected light that has passed through the through-hole.

2. The laser processing apparatus according to claim 1, further comprising a lens configured to condense the reflected light near the through-hole.
